(19) United States
(12) Patent Application Publication
(10) Pub. No.: US 2016/0057672 A1
(43) Pub. Date: Feb. 25, 2016

(54) METHOD AND APPARATUS FOR TRANSMITTING INFORMATION ON IN-DEVICE COEXISTENCE IN WIRELESS COMMUNICATION SYSTEM

(71) Applicant: LG ELECTRONICS INC., Seoul (KR)

(72) Inventors: Kyungmin PARK, Seoul (KR); Insun LEE, Seoul (KR); Daewook BYUN, Seoul (KR); Jian XU, Seoul (KR)

(73) Assignee: LG ELECTRONICS INC., Seoul (KR)

(21) Appl. No.: 14/779,510

(22) PCT Filed: Apr. 4, 2014
(86) PCT No.: PCT/KR2014/002917

§ 371 Date: Sep. 23, 2015

Related U.S. Application Data
(60) Provisional application No. 61/808,640, filed on Apr. 5, 2013.

(51) Int. Cl. H04W 36/08; H04W 36/20; H04L 1/18

(52) U.S. Cl. CPC H04W 36/08; H04L 1/1812; H04W 36/20

(57) ABSTRACT

A method and apparatus for transmitting information on in-device coexistence (IDC) interference in a wireless communication system is provided. A source eNodeB (eNB) initiates handover for a user equipment (UE), which experiences IDC interference at a source cell controlled by the source eNB, to a target eNB; and transmits information on IDC interference to the target eNB.

### TECHNICAL FIELD

The present invention relates to wireless communications, and more particularly, to a method and apparatus for transmitting information on in-device coexistence (IDC) in a wireless communication system.

### BACKGROUND ART

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The SGW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARM) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 2, the RLC and MAC layers (terminated in the eNB on the network side) may perform functions such as scheduling, automatic repeat request (ARQ), and hybrid automatic repeat request (HARM). The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped o the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined. The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof. This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance. There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULInterference, TransmitPilot and Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value in the UL in the signature.

Meanwhile, in order to allow users to access various networks and services ubiquitously, an increasing number of UEs are equipped with multiple radio transceivers. For example, a UE may be equipped with LTE, Wi-Fi, Bluetooth (BT) transceivers, etc., for wireless communication systems, and global navigation satellite system (GNSS) receivers. For example, a UE may be equipped with a LTE module and a Bluetooth module in order to receive a voice over Internet (VoIP) services and multimedia services using a Bluetooth earphone. A UE may be equipped with a LTE module and a Wi-Fi module in order to distribute traffics. A UE may be equipped with a LTE module and a GNSS module in order to acquire location information additionally.

Due to extreme proximity of multiple radio transceivers within the same UE, the transmit power of one transmitter may be much higher than the received power level of another receiver. By means of filter technologies and sufficient frequency separation, the transmit signal may not result in significant interference. But for some coexistence scenarios, e.g., different radio technologies within the same UE operating on adjacent frequencies or sub-harmonic frequencies, the interference power coming from a transmitter of the collocated radio may be much higher than the actual received power level of the desired signal for a receiver. This situation causes in-device coexistence (IDC) interference. The challenge lies in avoiding or minimizing IDC interference between those collocated radio transceivers, as current state-of-the-art filter technology might not provide sufficient rejection for certain scenarios. Therefore, solving the interference problem by single generic radio frequency (RF) design may not always be possible and alternative methods needs to be considered.

In some situations, IDC interference may be considered for mobility robustness optimization (MRO). The IDC problem has been presented related to the UE characteristics and grouping issues. Additional MRO issues related to the IDC problem may be discussed in 3GPP LTE rel-12 according to the current IDC features of 3GPP LTE. A method for considering a type of a UE suffering from the IDC problem may be required for solving MRO issues related to the IDC problem.

### SUMMARY OF INVENTION

### Technical Problem

The present invention provides a method and apparatus for transmitting information on in-device coexistence (IDC) in a wireless communication system. The present invention provides a method for transmitting, by a source eNodeB (eNB), information on in-device coexistence (IDC) problem to a target eNB when the source eNB initiates handover for a user equipment (UE).

### Solution to Problem

In an aspect, a method for transmitting, by a source eNodeB (eNB), information on in-device coexistence (IDC) interference in a wireless communication system is provided. The method includes initiating handover for a user equipment (UE), which experiences IDC interference at a source cell controlled by the source eNB, to a target eNB, and transmitting information on IDC interference to the target eNB.

The information on IDC interference may inform the target eNB whether the handover is to avoid the IDC interference or not.

The information on IDC interference may include a handover cause which is the IDC interference.

The information on IDC interference may inform the target eNB whether the IDC interference at the source cell can be solved or not.

The information on IDC interference may inform the target eNB of IDC problem solving ability at the source eNB.

The IDC problem solving ability may include at least one of a UE available data rate and a data loss rate at hybrid automatic repeat request (HARM) level.

In another aspect, a source eNodeB (eNB) in a wireless communication system is provided. The source eNB includes a radio frequency (RF) unit for transmitting or receiving a radio signal, and a processor coupled to the RF unit, and configured to initiate handover for a user equipment (UE), which experiences IDC interference at a source cell controlled by the source eNB, to a target eNB, and transmit information on IDC interference to the target eNB.

### Advantageous Effects of Invention

Mobility robustness optimization (MRO) problems related to IDC problem can be avoided.

### BRIEF DESCRIPTION OF DRAWINGS

FIG. 1 shows LTE system architecture.

FIG. 2 shows a control plane of a radio interface protocol of an LTE system.

FIG. 3 shows a user plane of a radio interface protocol of an LTE system.

FIG. 4 shows an example of a physical channel structure.

FIGS. 5 and 6 show an intra-MME/S-GW handover procedure.

FIG. 7 shows an example of IDC interference within a UE.

FIG. 8 shows 3GPP frequency bands around ISM band.

FIG. 9 shows an example of a TDM pattern according to a TDM solution.

FIG. 10 shows different phases of IDC interference related operations by a UE.

FIG. 11 shows an IDC indication procedure.

FIG. 12 shows a brief procedure for avoiding IDC interference.

FIG. 13 shows an example of a method for transmitting information on IDC interference according to an embodiment of the present invention.

FIG. 14 shows a wireless communication system to implement an embodiment of the present invention.

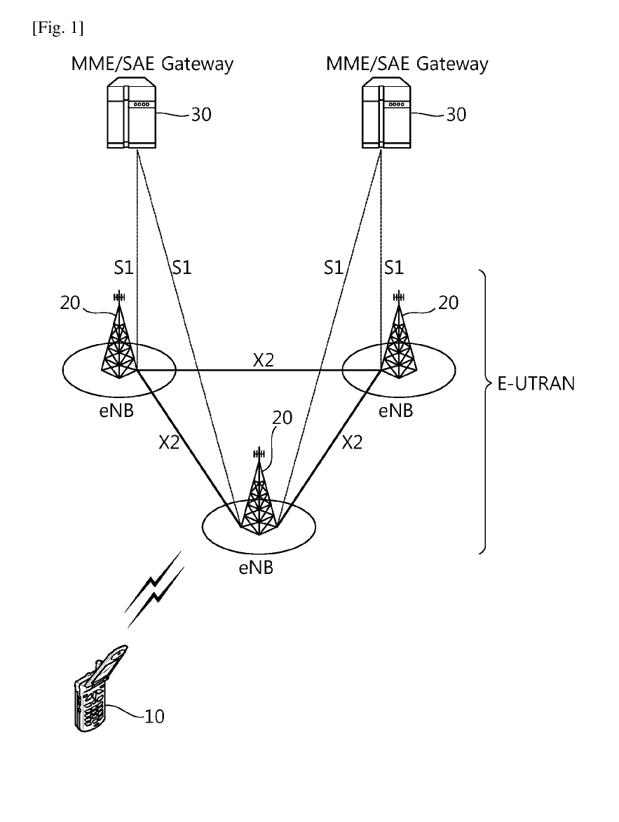

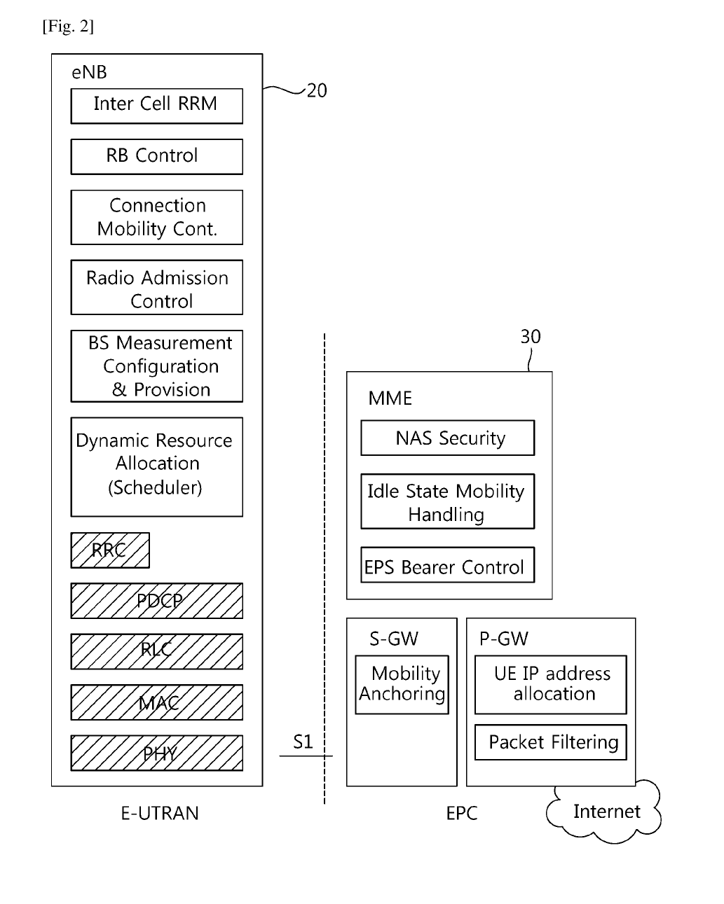

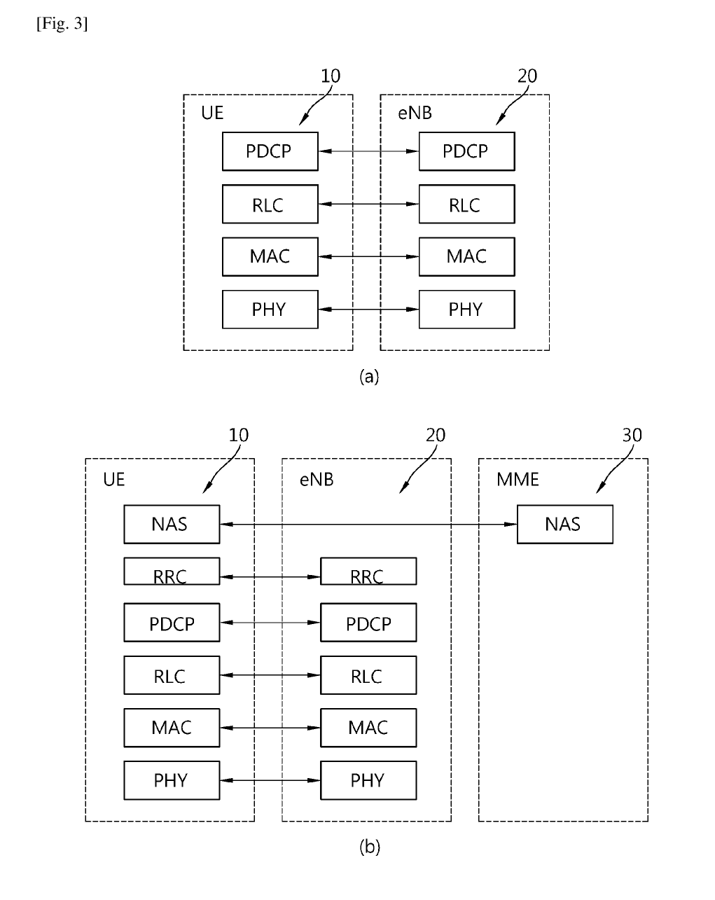

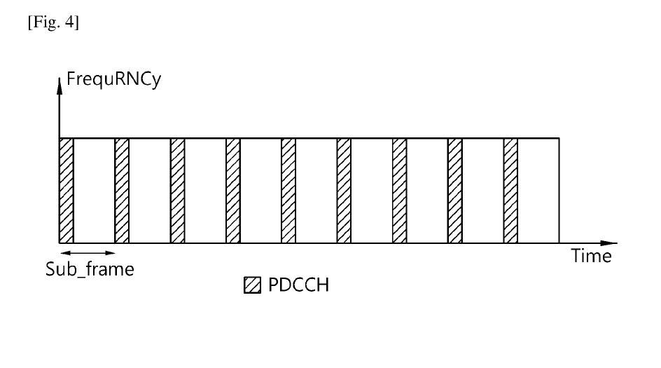

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink LTE-advance (LTE-A) is an evolution of the 3GPP LTE.

For clarity, the following description will focus on the LTE-A. However, technical features of the present invention are not limited thereto.

Handover (HO) is described. It may be referred to Section 10.1.2.1 of 3GPP TS 36.300 V11.4.0 (2012-12).

The intra E-UTRAN HO of a UE in RRC_CONNECTED state is a UE-assisted network-controlled HO, with HO preparation signaling in E-UTRAN:
Part of the HO command comes from the target eNB and is transparently forwarded to the UE by the source eNB;
To prepare the HO, the source eNB passes all necessary information to the target eNB (e.g., E-UTRAN radio access bearer (E-RAB) attributes and RRC context): When carrier aggregation (CA) is configured and to enable secondary cell (SCell) selection in the target eNB, the source eNB can provide in decreasing order of radio quality a list of the best cells and optionally measurement result of the cells.
Both the source eNB and UE keep some context (e.g., C-RNTI) to enable the return of the UE in case of HO failure;
UE accesses the target cell via RACH following a contention-free procedure using a dedicated RACH preamble or following a contention-based procedure if dedicated RACH preambles are not available: the UE uses the dedicated preamble until the handover procedure is finished (successfully or unsuccessfully);
If the RACH procedure towards the target cell is not successful within a certain time, the UE initiates radio link failure recovery using the best cell;
No robust header compression (ROHC) context is transferred at handover.

The preparation and execution phase of the HO procedure is performed without EPC involvement, i.e., preparation messages are directly exchanged between the eNBs. The release of the resources at the source side during the HO completion phase is triggered by the eNB. In case an RN is involved, its donor eNB (DeNB) relays the appropriate S1 messages between the RN and the MME (S1-based handover) and X2 messages between the RN and target eNB (X2-based handover); the DeNB is explicitly aware of a UE attached to the RN due to the S1 proxy and X2 proxy functionality.

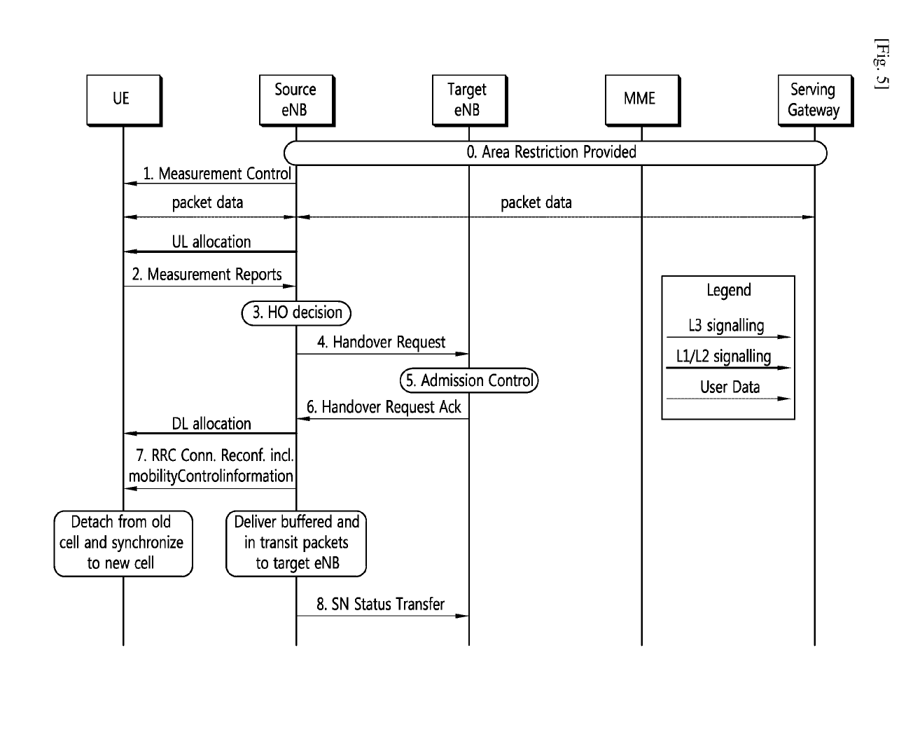

FIGS. 5 and 6 show an intra-MME/S-GW handover procedure.

0. The UE context within the source eNB contains information regarding roaming restrictions which were provided either at connection establishment or at the last TA update.

1. The source eNB configures the UE measurement procedures according to the area restriction information. Measurements provided by the source eNB may assist the function controlling the UE's connection mobility.

2. The UE is triggered to send measurement reports by the rules set by i.e., system information, specification, etc.

3. The source eNB makes decision based on measurement reports and radio resource management (RRM) information to hand off the UE.

4. The source eNB issues a handover request message to the target eNB passing necessary information to prepare the HO at the target side (UE X2 signalling context reference at source eNB, UE S1 EPC signalling context reference, target cell identifier (ID), K_{eNB*}, RRC context including the cell radio network temporary identifier (C-RNTI) of the UE in the source eNB, AS-configuration, E-RAB context and physical layer ID of the source cell+short MAC-I for possible radio link failure (RLF) recovery). UE X2/UE S1 signalling references enable the target eNB to address the source eNB and the EPC. The E-RAB context includes necessary radio network layer (RNL) and transport network layer (TNL) addressing information, and quality of service (QoS) profiles of the E-RABs.

5. Admission Control may be performed by the target eNB dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e., an “establishment”) or as a delta compared to the AS-configuration used in the source cell (i.e., a “reconfiguration”).

6. The target eNB prepares HO with L1/L2 and sends the handover request acknowledge to the source eNB. The handover request acknowledge message includes a transparent container to be sent to the UE as an RRC message to perform the handover. The container includes a new C-RNTI, target eNB security algorithm identifiers for the selected security algorithms, may include a dedicated RACH preamble, and possibly some other parameters, i.e., access parameters, SIBs, etc. The handover request acknowledge message may also include RNL/TNL information for the forwarding tunnels, if necessary.

As soon as the source eNB receives the handover request acknowledge, or as soon as the transmission of the handover command is initiated in the downlink, data forwarding may be initiated.

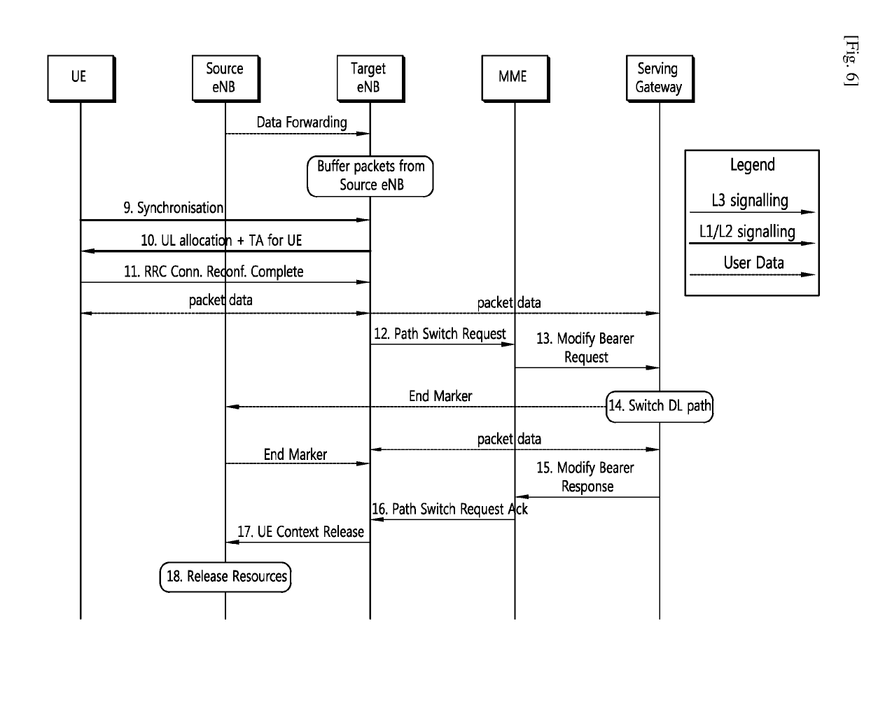

Steps 7 to 16 in FIGS. 6 and 7 provide means to avoid data loss during HO.

7. The target eNB generates the RRC message to perform the handover, i.e., RRCConnectionReconfiguration message including the mobilityControlInformation, to be sent by the source eNB towards the UE. The source eNB performs the necessary integrity protection and ciphering of the message. The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. The UE does not need to delay the handover execution for delivering the HARQ/ARQ responses to source eNB.

8. The source eNB sends the sequence number (SN) status transfer message to the target eNB to convey the uplink PDCP SN receiver status and the downlink PDCP SN transmitter status of E-RABs for which PDCP status preservation applies (i.e., for RLC AM). The uplink PDCP SN receiver status includes at least the PDCP SN of the first missing UL service data unit (SDU) and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.

9. After receiving the RRCConnectionReconfiguration message including the mobilityControlInformation, UE performs synchronization to target eNB and accesses the target cell via RACH, following a contention-free procedure if a dedicated RACH preamble was indicated in the mobilityControlInformation, or following a contention-based procedure if no dedicated preamble was indicated. UE derives target eNB specific keys and configures the selected security algorithms to be used in the target cell.

10. The target eNB responds with UL allocation and timing advance.

11. When the UE has successfully accessed the target cell, the UE sends the RRCConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin sending data to the UE.

12. The target eNB sends a path switch request message to MME to inform that the UE has changed cell.

13. The MME sends a modify bearer request message to the serving gateway.

14. The serving gateway switches the downlink data path to the target side. The Serving gateway sends one or more “end marker” packets on the old path to the source eNB and then can release any U-plane/TNL resources towards the source eNB.

15. The serving gateway sends a modify bearer response message to MME.

16. The MME confirms the path switch request message with the path switch request acknowledge message.

17. By sending the UE context release message, the target eNB informs success of HO to source eNB and triggers the release of resources by the source eNB. The target eNB sends this message after the path switch request acknowledge message is received from the MME.

18. Upon reception of the UE context release message, the source eNB can release radio and C-plane related resources associated to the UE context. Any ongoing data forwarding may continue.

In-device coexistence (IDC) is described. It may be referred to 3GPP TR 36.816 V11.2.0 (2011-12) and Section 23.4 of 3GPP TS 36.300 V11.5.0 (2013-03).

FIG. 7 shows an example of IDC interference within a UE.

A LTE module 70 includes a LTE baseband 71 and a LTE radio frequency (RF) 72. A global positioning system (GPS) module 80 includes a GPS baseband 81 and a GPS RF 82. A Bluetooth (BT)/Wi-Fi module 90 includes a BT/Wi-Fi baseband 91 and a BT/Wi-Fi RF 92. For example, if all of the LTE module 70, the GPS module 80 and the BT/Wi-Fi module 90 are switched on, the LTE module 70 may interfere the GPS module 80 and the BT/Wi-Fi module 90. Or the BT/Wi-Fi module 90 may interfere the LTE module 70.

Coexistence interference scenarios between LTE radio and other radio technologies are described. 3GPP frequency bands around 2.4 GHz industrial, scientific and medical (ISM) bands are considered.

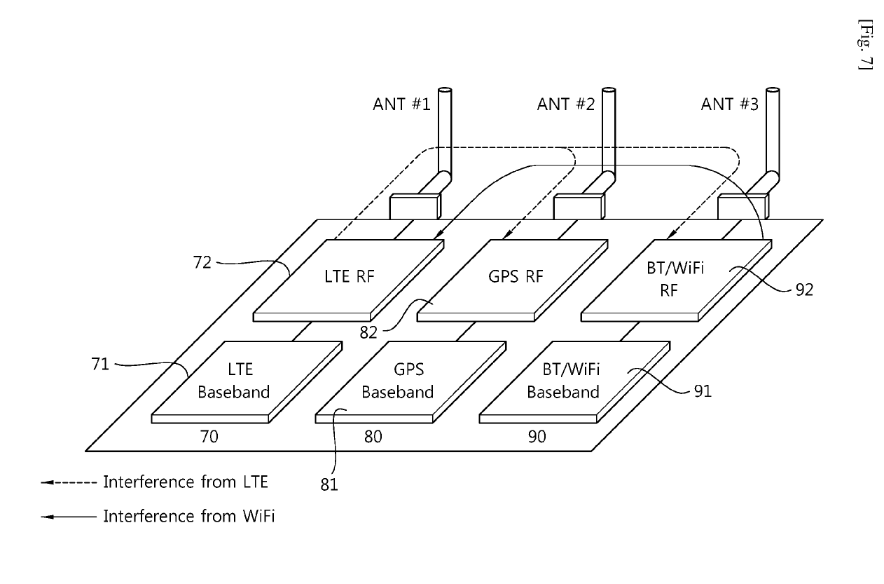

FIG. 8 shows 3GPP frequency bands around ISM band.

There are 14 channels demarcated in ISM band for Wi-Fi operation. Each channel has 5 MHz separation from other channel with an exception of channel number 14 where separation is 12 MHz. Channel 1 starts with 2401 MHz and channel 14 ends at 2495 MHz. Different countries have different policies for number of allowed channels of Wi-Fi. The transmitter of LTE band 40 may affect receiver of Wi-Fi and vice-versa. Since band 7 is a FDD band, so there is no impact on the LTE receiver from the Wi-Fi transmitter. But the Wi-Fi receiver will be affected by the LTE uplink transmitter.

Bluetooth operates in 79 channels of 1 MHz each in ISM band. The first channel starts with 2402 MHz and the last channel ends at 2480 MHz. Similar as Wi-Fi case, the activities of LTE 40 and Bluetooth may disturb each other, and the transmission of LTE band 7 UL may affect Bluetooth reception as well.

Three modes are considered in order to avoid the IDC interference according to whether there is coordination between a LTE module and other coexisting radio modules or not and whether there is coordination between the LTE module and an eNB or not. At first, in an uncoordinated mode, different radio technologies within the same UE operate independently without any internal coordination between each other. The LTE module and the network do not have any coordination between each other, either. In this case, the LTE module cannot handle appropriately of service quality due to the IDC interference as the LTE module does not know information on other coexisting radio modules. Secondly, in a UE-coordinated mode, there is an internal coordination between the different radio technologies within the same UE, which means that at least the activities of one radio is known by other radio. Each radio module can know on/off status and/or traffic transmission status of other radio modules within the UE. However, the network is not aware of the coexistence issue possibly experienced by the UE and is therefore not involved in the coordination. Third, in a network-coordinated mode, the different radio technologies within the UE are aware of possible coexistence problems and the UE can inform the network about such problems. It is then mainly up to the network to decide how to avoid IDC interference.

The LTE module may measure the IDC interference by cooperating with other radio modules within the UE or by inter/intra frequency measurements.

When a UE experiences IDC problems that it cannot solve by itself and a network intervention is required, it sends an IDC indication via dedicated RRC signaling to report the IDC problems to the eNB. The UE may rely on existing LTE measurements and/or UE internal coordination to assess the interference and the details are left up to UE implementation. For instance, the interference is applicable over several subframes/slots where not necessarily all the subframes/slots are affected and consists of interference caused by the aggressor radio to the victim radio during either active data exchange or upcoming data activity which is expected in up to a few hundred milliseconds.

A UE that supports IDC functionality indicates this capability to the network, and the network can then configure by dedicated signaling whether the UE is allowed to send an IDC indication. The IDC indication can only be triggered for frequencies for which a measurement object is configured and when:
for the primary frequency, the UE is experiencing IDC problems that it cannot solve by itself;
for a secondary frequency, regardless of the activation state of the corresponding secondary cell (SCell), the UE is experiencing or expects to experience upon activation IDC problems that it cannot solve by itself;
for a non-serving frequency, the UE expects to experience IDC problems that it cannot solve by itself if that non-serving frequency becomes a serving one.

When notified of IDC problems through an IDC indication from the UE, the eNB can choose to apply a frequency division multiplexing (FDM) solution or a time division multiplexing (TDM) solution:
The basic concept of an FDM solution is to move the LTE signal away from the ISM band by e.g., performing inter-frequency handover within E-UTRAN or removing SCells from the set of serving cells.
The basic concept of a TDM solution is to ensure that transmission of a radio signal does not coincide with reception of another radio signal. LTE discontinuous reception (DRX) mechanism is used to provide TDM patterns (i.e., periods during which the LTE UE may be scheduled or is not scheduled) to resolve the IDC issues. DRX based TDM solution should be used in a predictable way, i.e., the eNB should ensure a predictable pattern of unscheduled periods by means of DRX mechanism.

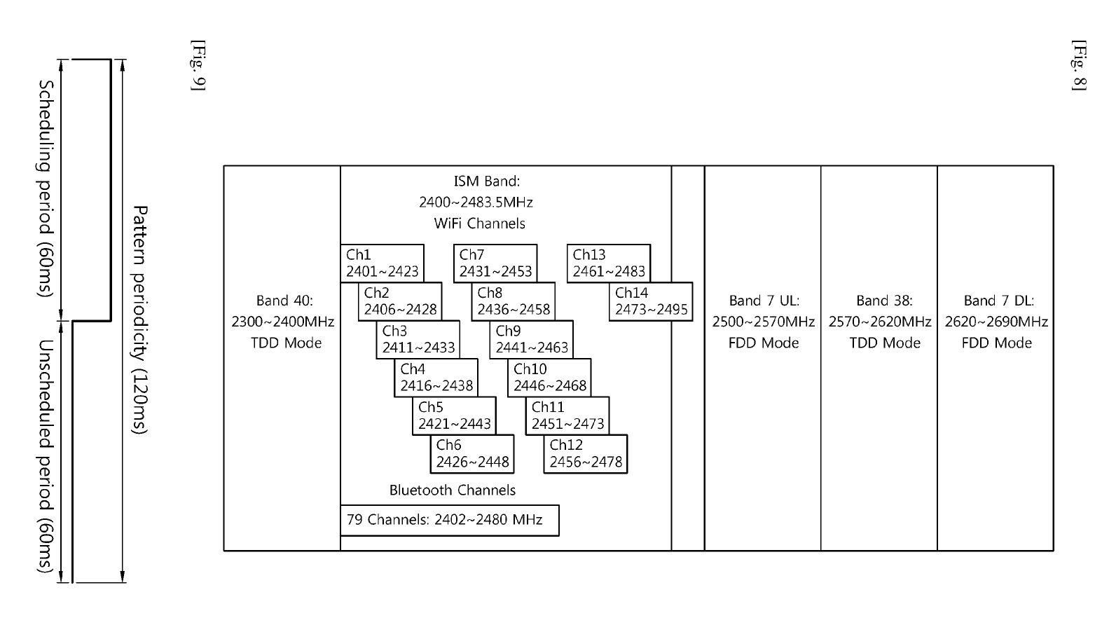

FIG. 9 shows an example of a TDM pattern according to a TDM solution.

The UE may provide the eNB with a desired TDM pattern. For example, the parameters related to the TDM pattern can consist of a periodicity of the TDM pattern, and a scheduling period (or unscheduled period). Referring to FIG. 9, a periodicity of a TDM pattern is 120 ms. A LTE module performs transmission or reception using only a scheduling period having a length of 60 ms. Another coexisting radio technology module performs transmission or reception using only an unscheduled period having a length of 60 ms.

To assist the eNB in selecting an appropriate solution, all necessary/available assistance information for both FDM and TDM solutions is sent together in the IDC indication to the eNB. The IDC assistance information contains the list of E-UTRA carriers suffering from IDC problems, the direction of the interference and, depending on the scenario, it also contains TDM patterns or parameters to enable appropriate DRX configuration for TDM solutions on the serving E-UTRA carrier. The IDC indication is also used to update the IDC assistance information, including for the cases when the UE no longer suffers from IDC problems. In case of inter-eNB handover, the IDC assistance information is transferred from the source eNB to the target eNB.

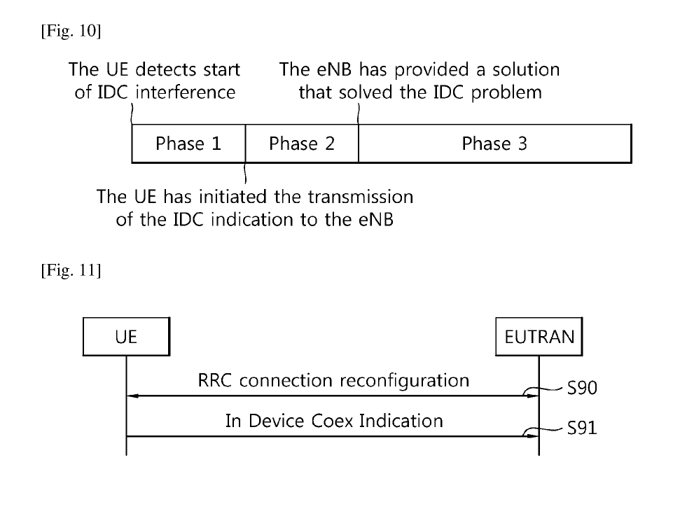

FIG. 10 shows different phases of IDC interference related operations by a UE.

IDC interference situation may be divided into following three phases according to FIG. 10. In phase 1, the UE detects start of IDC interference but does not initiate the transmission of the IDC indication to the eNB yet. In phase 2, the UE has initiated the transmission of the IDC indication to the eNB and no solution is yet configured by the eNB to solve the IDC issue. In phase 3, the eNB has provided a solution that solved the IDC interference to the UE.

In different phases, UE behaviors related to radio resource management (RRM), radio link management (RLM), and channel state information (CSI) measurements are shown in Table 1.

TABLE 1

| Phases of | | | |
|---|---|---|---|
| IDC In- | | | |
| terference | RRM Measurements | RLM Measurements | CSI Measurements |
| Phase 1 | Up to UE imple- | Up to UE imple- | Up to UE imple- |
| | mentation and RRM | mentation and RLM | mentation and CSI |
| | measurement re- | measurement re- | measurement re- |
| | quirements | quirements | quirements |
| Phase 2 | UE shall ensure the | UE shall ensure the | |
| | measurements are free | measurements are free | |
| | of IDC interference | of IDC interference | |
| | and RRM mea- | and RLM measurement | |
| | surement requirements | requirements | |
| Phase 3 | UE shall ensure the | UE shall ensure the | |
| | measurements are free | measurements are free | |
| | of IDC interference | of IDC interference | |
| | and RRM mea- | and RLM measurement | |
| | surement requirements | requirements | |

The UE should attempt to maintain connectivity to LTE in the phase 2 meaning that RLM measurements are not impacted by IDC interference. If no solution is provided within a time which is up to UE implementation, the UE may need to declare RLF or it may continue to deny the ISM transmission. If the UE determines in the phase 2 that the network does not provide a solution that resolves its IDC problems, it performs measurements as defined for the phase 1. If the IDC indication message reports the IDC interference on a neighbor frequency, it performs RRM measurements for that frequency as defined for the phase 2.

In addition, once configured by the network, the UE can autonomously deny LTE UL transmission in all phases to protect ISM in rare cases if other solutions cannot be used. Conversely, it is assumed that the UE also autonomously denies ISM transmission in order to ensure connectivity with the eNB to perform necessary LTE procedures, e.g., RRC connection reconfiguration and paging reception, etc. The network may configure a long-term denial rate by dedicated RRC signaling to limit the amount of LTE UL autonomous denials. Otherwise, the UE shall not perform any LTE UL autonomous denials.

IDC indication is described. It may be referred to Section 5.6.9 of 3GPP TS 36.331 V11.3.0 (2013-03). The purpose of this procedure is to inform the E-UTRAN about (a change of) the IDC problems experienced by the UE in RRC_CONNECTED, and to provide the E-UTRAN with information in order to resolve them.

FIG. 11 shows an IDC indication procedure. At step S90, the UE and the E-UTRAN performs an RRC connection reconfiguration procedure. At step S91, the UE transmits an InDeviceCoexIndication message to the E-UTRAN on a DCCH.

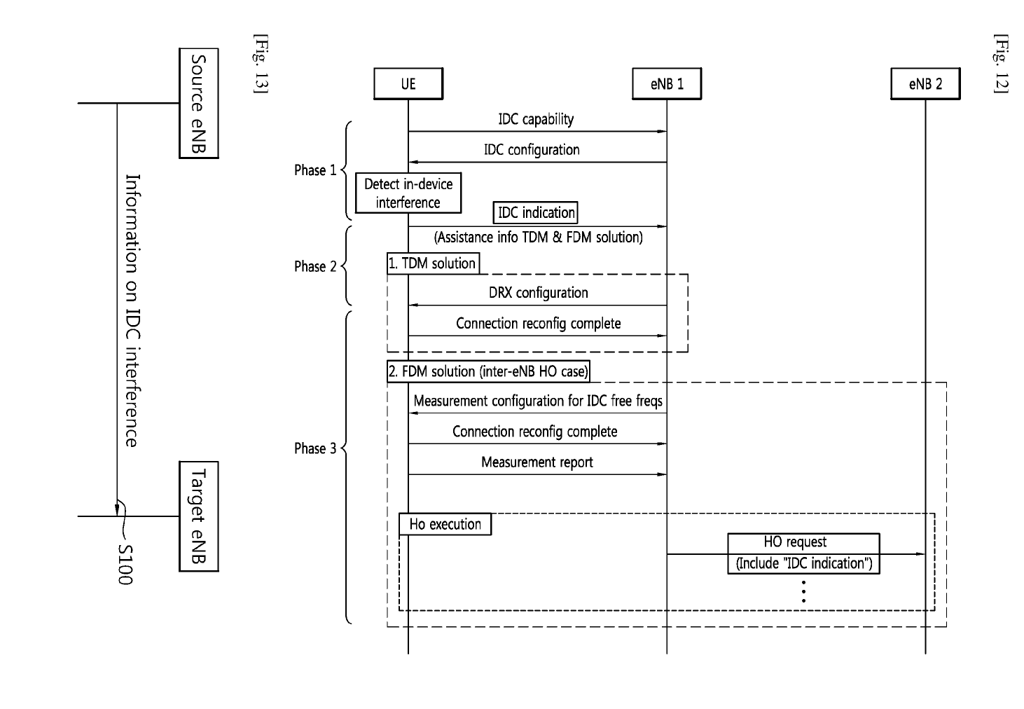

FIG. 12 shows a brief procedure for avoiding IDC interference. In phase 1, upon receiving IDC configuration from the eNB, the UE detects start of IDC interference. In phase 2, the UE initiates the transmission of the IDC indication to the eNB, which contains all necessary/available assistance information for both FDM and TDM solutions. In phase 3, the eNB provides a FDM or TDM solution that solves the IDC interference to the UE. If the TDM solution is provided, the eNB may provide the DRX configuration to the UE. If the FDM solution is provided, the eNB may provide the measurement configuration for IDC-free frequencies.

According to the description above, the IDC indication is the essential part to develop solution for IDC interference, which is the only means to make the eNB recognize the IDC interference. However, the IDC indication does not seem to be sufficient for existing and further MRO issues. For example, when the RLF occurs due to the IDC interference, the UE does not report that the cause of the RLF was the IDC interference. Moreover, in the handover procedure, any IDC related information except the IDC indication is not transferred to the target eNB from the source eNB. The followings are examples of MRO issues which may occur due to the IDC interference.

1) Detection Problem of RLF Cause

When the RLF occurs due to the IDC interference, the re-established eNB is not reported the actual RLF reason. Though the UE transfers the IDC indication to the eNB, the eNB is merely able to estimate that there were the IDC interferences from the IDC indication. Consequentially, the re-established eNB cannot report the actual RLF reason to the source eNB. As a result, the source eNB is not possible to detect the RLF cause as well. For example, the source eNB performs an inter-frequency handover for the UE to the target eNB, and in the target eNB, the UE loses its radio link connection due to the IDC interference. After the RLF occurs, the UE re-establishes to the source eNB again. In this case, the source eNB does not know about the RLF cause of the IDC interference, and considers the RLF case as too early handover.

2) Selection Problem as a Target Cell Candidate

When the UE is handed over, the IDC indication is included in the handover request message. The IDC indication only informs the amount of the IDC interference, and does not contain the IDC-problem-solving ability at the source eNB. That is, though the target eNB knows about that the UE had the IDC interference in the source cell, it is not possible to know about if the IDC interference can be solved in the source cell or not. It means that the target eNB cannot decide whether to select the source eNB as the next target eNB for the next handover or not. For example, the source eNB hands over the UE, which has IDC interference which can be avoided by TDM solution, to the target eNB. If the UE faces serious IDC interference which cannot be avoided in the target cell, and if the target eNB misunderstands that the IDC interference in the source cell was also serious, then the target eNB may not let the UE handover back to the source eNB. Consequentially, this decision may cause a link failure of the UE.

In order to avoid MRO problems related to the IDC interference described above, effective solutions may be required. Hereinafter, a method for transmitting information on IDC interference according to an embodiment of the present invention is described.

FIG. 13 shows an example of a method for transmitting information on IDC interference according to an embodiment of the present invention. In step S100, when the source eNB initiates handover for the UE, the source eNB transmits information on IDC interference to the target eNB. The information on IDC interference may inform the target eNB whether the handover is to avoid the IDC interference or not. Alternatively, the information on IDC interference may inform the target eNB whether the IDC interference can be solved in the source cell or not. Alternatively, the information on IDC interference may inform the target eNB of the “IDC-problem-solving ability” at the source eNB. In this case, the “IDC-problem-solving ability” may include at least one of “UE available data rate (expressed as a ratio from maximum)” and “Data loss rate at HARQ level”.

“UE available data rate (expressed as a ratio from maximum)” and “Data loss rate at HARQ level” may be shown in Table 2 below. It may be referred to Table 5.2.1.2.1-1 of 3GPP TR 36.816 V11.2.0 (2011-12). Table 2 shows an example of the performance analysis of three scenarios for solution of the IDC interference.

TABLE 2

| | UE available data | | Standard- |
|---|---|---|---|
| | rate (expressed | Data loss | ization |
| | as a ratio from | rate at | impact on DRX |
| Case | maximum) | HARQ level | and HARQ |
| Default DRX con- | 14% | Close to 0% | No |
| figuration | | | |
| IDC tuned DRX | 33% | 1% in UL | No |
| configuration | | and DL | |
| IDC optimized DRX | 39% | Depends on the | Yes |
| mechanism | | solution and | |
| | | scenario | |

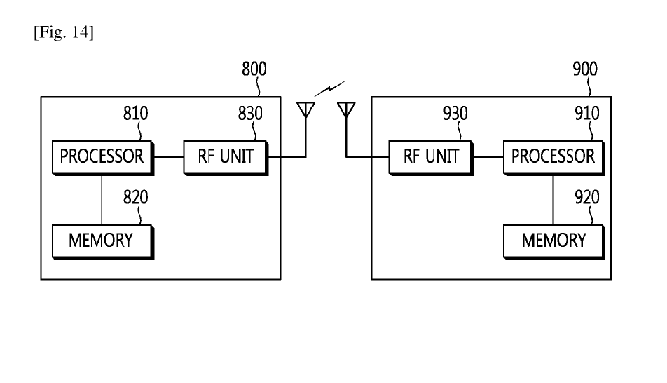

FIG. 14 shows a wireless communication system to implement an embodiment of the present invention.

A first eNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A second eNB 900 may include a processor 910, a memory 920 and a RF unit 930.

The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for transmitting, by a source eNodeB (eNB), information on in-device coexistence (IDC) interference in a wireless communication system, the method comprising:
initiating handover for a user equipment (UE), which experiences IDC interference at a source cell controlled by the source eNB, to a target eNB; and
transmitting information on IDC interference to the target eNB.

2. The method of claim 1, wherein the information on IDC interference informs the target eNB whether the handover is to avoid the IDC interference or not.

3. The method of claim 1, wherein the information on IDC interference includes a handover cause which is the IDC interference.

4. The method of claim 1, wherein the information on IDC interference informs the target eNB whether the IDC interference at the source cell can be solved or not.

5. The method of claim 1, wherein the information on IDC interference informs the target eNB of IDC problem solving ability at the source eNB.

6. The method of claim 5, wherein the IDC problem solving ability includes at least one of a UE available data rate and a data loss rate at hybrid automatic repeat request (HARD) level.

7. A source eNodeB (eNB) in a wireless communication system, the source eNB comprising:
a radio frequency (RF) unit for transmitting or receiving a radio signal; and
a processor coupled to the RF unit, and configured to:
initiate handover for a user equipment (UE), which experiences IDC interference at a source cell controlled by the source eNB, to a target eNB; and
transmit information on IDC interference to the target eNB.

8. The source eNB of claim 7, wherein the information on IDC interference informs the target eNB whether the handover is to avoid the IDC interference or not.

9. The source eNB of claim 7, wherein the information on IDC interference includes a handover cause which is the IDC interference.

10. The source eNB of claim 7, wherein the information on IDC interference informs the target eNB whether the IDC interference at the source cell can be solved or not.

11. The source eNB of claim 7, wherein the information on IDC interference informs the target eNB of IDC problem solving ability at the source eNB.

12. The source eNB of claim 11, wherein the IDC problem solving ability includes at least one of a UE available data rate and a data loss rate at hybrid automatic repeat request (HARD) level.
